(19) United States
(12) Patent Application Publication
(10) Pub. No.: US 2007/0045969 A1
(43) Pub. Date: Mar. 1, 2007

(54) FACE SEAL

(75) Inventor: James L. Cairns, Ormond Beach, FL (US)

Correspondence Address: PROCOPIO, CORY, HARGREAVES & SAVITCH LLP, 530 B STREET, SUITE 2100, SAN DIEGO, CA, 92101, US

(73) Assignee: Ocean Design, Inc.

(21) Appl. No.: 11/468,260

(22) Filed: Aug. 29, 2006

Related U.S. Application Data
(60) Provisional application No. 60/712,094, filed on Aug. 29, 2005.

(51) Int. Cl. F16L 21/02

(52) U.S. Cl. 277/616

(57) ABSTRACT

An elongate face seal of elastomeric material which may be formed as a continuous ring is adapted to provide a seal between two opposing, substantially flat surfaces. The seal is of relatively soft material to conform to the opposing surfaces to be sealed, and is of generally rectangular cross-sectional shape with opposing, generally flat seal faces for sealing engagement with the opposing surfaces to be sealed. Opposite side edges of the seal are rounded. The seal is elongated in the transverse direction to provide a greater area of contact with the surfaces to be sealed, allowing the seal to bridge over larger irregularities than would be possible with an O-ring face seal.

### RELATED APPLICATION

The present application claims the benefit of co-pending U.S. provisional patent application No. 60/712,094, filed on Aug. 29, 2005, which is incorporated herein by reference in its entirety.

### BACKGROUND

1. Field of the Invention

The present invention relates to face seals for providing a seal between opposing first and second surfaces.

2. Related Art

Face seals typically comprise flat rings or packings of rigid or semi-rigid material which are mounted between two opposing faces to seal any gap between the faces. In one arrangement, a face seal or gasket is mounted in a groove in one of the faces and is tightened between the groove and the opposing face, creating a pressure within the packing or gasket. The pressure thus developed in the seal must exceed the maximum applied external pressure which the gasket is intended to seal against. If the applied pressure exceeds the pressure created by tightening the gasket or packing, it will further compress and leak.

O-rings are another type of seal that differs fundamentally from gaskets and packings in that the seal is created by the elastic properties of the squeezed O-ring, and not on its initial pressurization. When installed, the o-ring is elastically deformed by being squeezed into a different shape, but it is not pressurized. It's the elastic restoring force of the seal that tries to restore it to its round cross-section and in doing so seats it to the surfaces to be sealed. One problem with an O-ring face seal is that the contact between the seal's surface and the opposing surfaces to be sealed is relatively small, due to the round cross-sectional shape of the seal. This means that the seal can be unsuitable for sealing irregular surfaces, since it may be unable to conform to, or bridge over, irregularities in the opposing surfaces. Foreign objects such as sand grains or silt particles on the opposing surfaces to be sealed may also cause such a narrow O-ring seal to leak.

There are therefore many applications for which O-ring seals are not appropriate, such as where the surfaces are more irregular than O-rings can accommodate, or in environments where granular particles may be introduced between the surfaces to be sealed.

### SUMMARY

According to one aspect of the present invention, a face seal is provided which comprises an elongate member of elastomeric material which may be formed as a continuous ring and which is adapted to provide a seal between two opposing surfaces. The seal member is of softer material than conventional face seals which are generally rigid or semi-rigid, allowing it to conform more readily to the opposing surfaces to be sealed. The seal member has a generally rectangular cross-sectional shape with opposing seal faces for sealing engagement with the opposing surfaces to be sealed, and may have rounded opposite side edges in one embodiment. The rounded side edges which are exposed to external or internal pressure will reduce any tendency for the seal to extrude into the seam between the opposing surfaces to be sealed, potentially allowing higher pressure operation. In an exemplary embodiment, the seal member is elongated in the transverse direction. This provides a greater area of contact of the seal with the surfaces to be sealed, allowing the seal to bridge over larger irregularities than would be possible with an O-ring face seal. The opposing seal faces of the seal member may be generally flat for conforming with the opposing surfaces to be sealed.

In one embodiment, the face seal member is seated in a groove in one of the surfaces to be sealed and has a thickness between the opposing seal faces in the relaxed state which is greater than the depth of the groove, so that the seal member projects up out of the groove in the relaxed, un-installed condition. When the opposing surfaces to be sealed are brought together, the face seal member is squeezed into the groove so as to press against the opposing surfaces with sufficient pressure to form a seal.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a perspective view of a ring-shaped face seal according to one embodiment;

FIG. 2 is a cross-section on the lines 2-2 of FIG. 1;

FIG. 3 is a front elevation view of the seal of FIGS. 1 and 2;

FIG. 4 is an enlarged cross-sectional view illustrating the face seal seated in a groove in a first surface to be sealed and sealed between the groove and an opposing, second surface; and

FIG. 5 is a side view similar to FIG. 4 illustrating the seal when an external pressure is applied.

### DETAILED DESCRIPTION

Certain embodiments as disclosed herein provide for a face seal device providing a seal between opposing generally flat surfaces. For example, one seal device as disclosed herein allows for sealing between surfaces which may be uneven or irregular.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

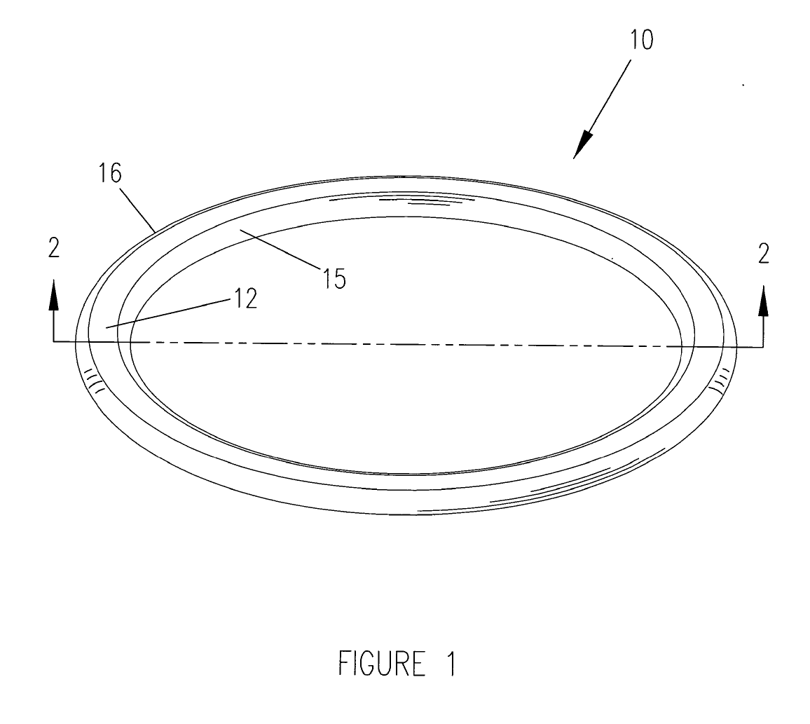

FIGS. 1 to 3 illustrate a face seal 10 according to one embodiment. Although the seal 10 in the illustrated embodiment is in the form of a generally circular ring, it may alternatively be a continuous loop of any desired shape, such as elongated or oval, depending on the shape defined by the opposing surfaces to be sealed, or may be an elongated linear face seal.

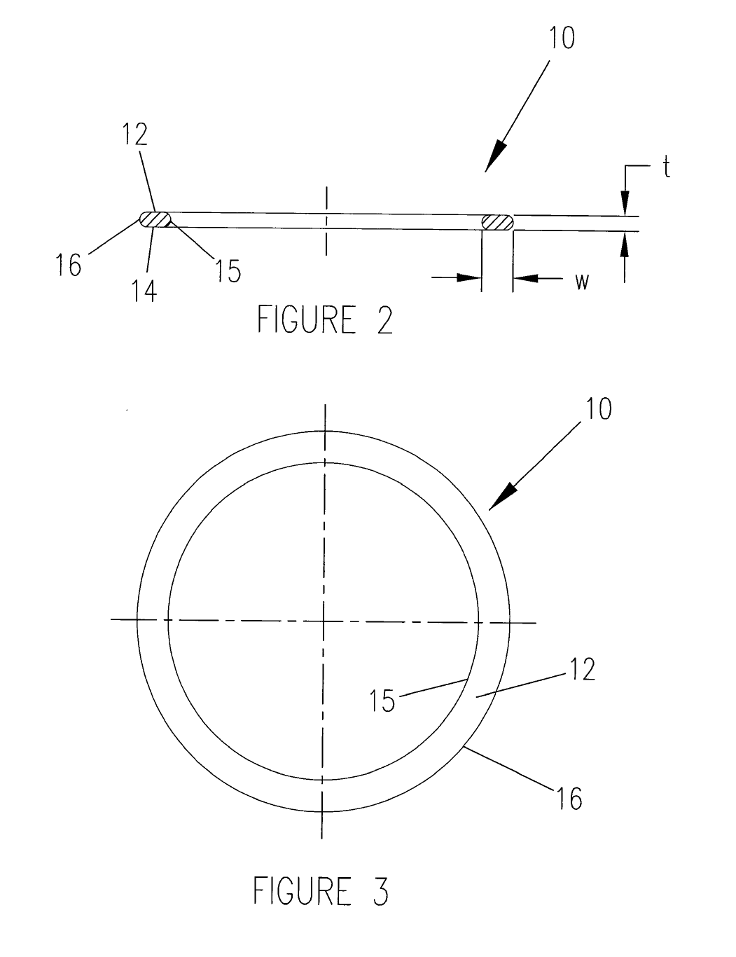

Seal 10 has a similar, band-like cross-sectional shape to an elastic band and can be made of a softer material than a typical O-ring. The seal material may be rubber-like, substantially incompressible, elastomeric material. As best seen in FIGS. 1 and 2, the seal has generally flat, opposing seal faces 12,14 and rounded inner and outer radial edges 15,16. The seal is of generally rectangular cross-sectional shape in the radial direction or the direction transverse to the longitudinal axis of the seal (FIG. 2) and is elongated in the radial direction, i.e. the radial width w of the seal is greater than the thickness t between the opposing seal faces, as seen in FIG. 2.

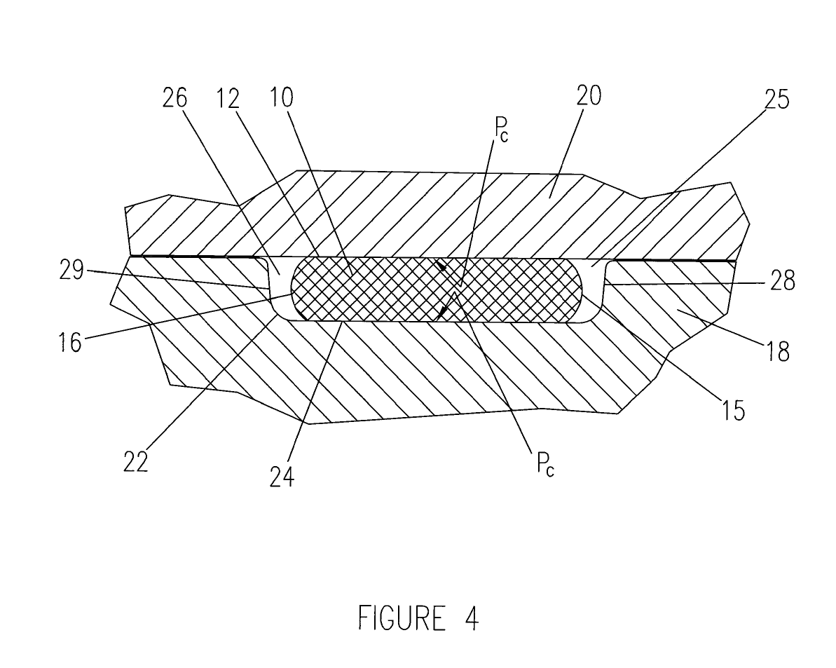

FIG. 4 illustrates the seal 10 installed between opposing substantially flat surfaces of members 18,20. A groove 22 of suitable shape for receiving the seal or ring 10 is provided in the surface of member 18. FIG. 4 illustrates the seal 10 in a non-energized condition in which external pressure is not applied to the seal. Like an O-ring, the face seal 10 relies on seating pressure P_{c} to create a seal. P_{c} is the pressure exerted between the inner surface 24 of the groove 22 and the opposing portion of the surface of member 20, produced by squeezing the elastic seal between the opposing surfaces. The axial contact area of seal faces 12 and 14 with the opposing sealing surfaces is much greater than that of an O-ring seal. As a result, seal 10 can conform to, or bridge over, much larger or axially longer irregularities than can an O-ring seal. Due to the much more extensive surface contact, seal 10 can be used effectively with much lower seating pressures. Typically, the seating pressure P_{c} of seal 10 may be in a range of approximately 20 PSI to 200 PSI.

Seal 10 in the illustrated embodiments has rounded inner and outer radial edges 15,16, rather than flat edges. Rounded seal edges can help support higher external pressures. The relative dimensions of the seal 10 and the groove 22 in which it is seated are selected such that the seal is under enough radial squeeze to form a seal between the groove 22 and opposing surface 20 prior to being energized. This is achieved by ensuring that the cross-sectional area of the seal 10 in the sealing direction slightly exceeds the cross-sectional area of the groove in which it resides. This means that seal 10 will project slightly out of groove 22 when in a relaxed or non-squeezed condition.

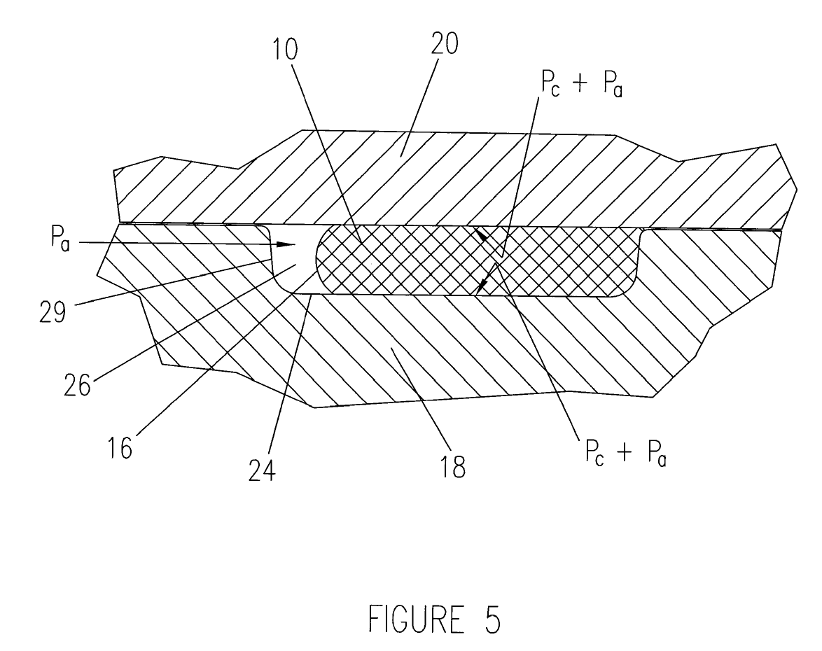

It can be seen that seal 10 does not completely fill the groove 22 in the squeezed condition of FIG. 4. As shown, there are small gaps or clearances 25,26 between the inner and outer radial edges 15,16 of the seal 10 and the corresponding inner and outer radial sides or edges 28,29 of the groove in which it is seated when the seal is not exposed to an external pressure. FIG. 5 illustrates seal 10 in an energized condition, i.e. when an environmental or external pressure Pₐ is applied to one radial edge or face of the seal via the small gap 26 between the opposing edges of the seal and groove. Application of an external pressure to seal 10 causes it to slide along the groove until it meets the opposing radial end or wall 28 of the groove 22 on the side opposite to the applied pressure Pₐ, as illustrated in FIG. 5. At this point, the seal is energized. At the interface between the seal faces 12,14 and the opposing portions of surface 20 and the base 24 of groove 22, there is an un-seating pressure equal to the applied pressure Pa. At the same time, the pressure holding the seal against these surfaces is equal to Pₐ+P_{c}, which always exceeds Pₐ. This additional pressure keeps the face seal 10 seated regardless of the applied external pressure.

When designing the dimensions of the seal 10 relative to the groove in which it is seated, the effects of swelling or shrinkage of the seal due to thermal expansion and contraction and due to chemical effects are considered. When designing seals, materials are chosen which minimize chemical effects, based on the seal application. For example, in an underwater application in which the seal is exposed to seawater, seal material is chosen which has little or no reaction with seawater. Suitable seal materials for such an application are rubber-like materials. The effects of thermal expansion and contraction are also considered. Such thermal effects can be accommodated by adjusting the groove volume appropriately, based on the coefficient of thermal expansion of the elastomer material used for seal 10.

Another factor in choosing the dimensions of the relaxed seal 10 and the seating groove 22 is to ensure that there is some free space or volume in the cavity when it is occupied by the squeezed seal. Because the seal is squeezed within the groove, the free volume comprises a gap between the seal and one or both radial edges of the groove. In FIG. 4, gaps 25,26 remain on both sides of seal 10, although there may be a gap at only one side of seal 10 in alternative arrangements. The gap or gaps are required to allow for manufacturing tolerances and for thermal or chemical expansion of the seal without its volume exceeding that of the cavity. The desired size of the gap or gaps therefore determines the radial widths of the seal 10 and the groove 22 in which it is seated.

The parameters of seal 10 which should be selected to provide the desired seal properties are as follows:
1. The applied pressure P_{c} across the seal. This pressure may be less than the pressure applied by a typical O-ring face seal.
2. The relative dimensions of the seal and the cavity or groove in which it is seated. The seal has a thickness between its opposite seal faces in a relaxed state which is greater than the depth of the groove in which it is seated, and has a radial width when squeezed which is less then the radial width of the groove.
3. The length or contact area provided by seal surfaces 12 and 14 is sufficient to bridge all irregularities or particles of debris on the surfaces 18,20 to be sealed.
4. The seal material. This material is selected to be chemically compatible with all elements with which it comes into contact, and is a soft, elastic, and substantially incompressible material.

The band-like face seal 10 illustrated in FIGS. 1 to 5 is radially wide and soft in comparison to a conventional O-ring face seal which is typically of more rigid material. Due to the relatively large sealing area of the opposing seal faces 12,14, the seal 10 can bridge over irregularities in the opposing surfaces to be sealed, and can also bridge across foreign objects such as sand grains or silt particles.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A face seal device, comprising:
an elongate seal member of elastomeric material having opposite seal faces and opposite side edges;
the seal faces being configured for sealing engagement with opposing surfaces to be sealed when the seal member is mounted between the opposing surfaces; and
the seal member having a thickness between the opposite seal faces which is less than a transverse width of the seal member between the opposite side edges.

2. The face seal of claim 1, wherein the seal faces are substantially flat.

3. The face seal of claim 1, wherein the seal member comprises a continuous ring having a central axis, the seal faces comprise the opposite axial faces of the ring and the side edges comprise the inner and outer radial edges of the ring.

4. The face seal of claim 1, wherein the side edges of the seal member are rounded.

5. A face seal assembly, comprising:
a first member having a first surface;
a second member having a second surface in substantial face-to-face engagement with the first surface;
the first surface having a groove with an inner surface and opposite side walls;
an elongate seal member of elastomeric material seated in the groove and having opposite seal faces in sealing engagement with the inner surface of the groove and an opposing portion of the second surface;
the seal member having a thickness between the opposite seal faces in a relaxed condition which is greater than the depth of the groove, whereby the seal member is squeezed between the opposing surfaces of the groove and second surface to apply a sealing pressure to the opposing surfaces;
the seal member being of generally rectangular cross-section and having a transverse width between the opposite side edges which is greater than the thickness of the seal member; and
the transverse cross-sectional dimensions of the seal member in the squeezed condition being less than the transverse cross-sectional dimensions of the groove, whereby a gap is located between the seal member and at least one side wall of the groove.

6. The assembly as claimed in claim 5, wherein the opposite side edges of the seal member are rounded.

7. The assembly as claimed in claim 5, wherein the seal member comprises an endless loop having a central axis and the groove is in the shape of a loop of corresponding dimensions to the seal member loop, the opposite seal faces comprising axial end faces of the seal member and the opposite side edges comprising inner and outer edges of the loop.

8. The assembly as claimed in claim 7, wherein the loop is of circular shape.

9. A face seal assembly, comprising:
a first member having a first surface;
a second member having a second surface in substantial face-to-face engagement with the first surface;
the first surface having a ring-shaped groove with an inner surface and opposite side walls;
a face seal ring of elastomeric material seated in the groove and having inner and outer radial edges and opposite seal faces in sealing engagement with the inner surface of the groove and an opposing portion of the second surface;
the seal ring having an axial thickness between the opposite seal faces in a relaxed condition which is greater than the axial depth of the groove, whereby the seal member is squeezed between the opposing surfaces of the groove and second surface to apply a sealing pressure to the opposing surfaces;
the seal ring being of generally rectangular cross-section and having a radial width between the inner and outer radial edges which is greater than the axial thickness of the seal member; and
the radial cross-sectional dimensions of the seal ring and the groove being adapted such that a gap is located between the seal member and at least one side wall of the groove.

10. The assembly of claim 9, wherein the inner and outer radial edges of the seal ring are rounded.

11. The assembly of claim 9, wherein the seal ring is a circle.

12. The assembly of claim 9, wherein the seal ring is a non-circular loop.

13. The assembly of claim 9, wherein the seal faces are substantially flat.
